(19) United States
(12) Patent Application Publication
(10) Pub. No.: US 2017/0186235 A1
(43) Pub. Date: Jun. 29, 2017

(54) AUGMENTED REALITY SYSTEM

(71) Applicant: IDVISION LIMITED, Wanchai, Hong Kong (CN)

(72) Inventor: Jason Chu, Wan Chai, Hong Kong (CN)

(73) Assignee: IDVISION LIMITED, Wanchai, Hong Kong (CN)

(21) Appl. No.: 15/325,294

(22) PCT Filed: Jul. 10, 2015
(86) PCT No.: PCT/IB2015/055221

§ 371 Date: Jan. 10, 2017

(30) Foreign Application Priority Data
Jul. 11, 2014 (HK) 14107099.9

(51) Int. Cl. G06T 19/00

(52) U.S. Cl. CPC G06T 19/006; G06T 2207/30204

(57) ABSTRACT

A method and system for generating augmented reality images for display on a computing device is disclosed. Embodiments of the method include acquiring at least one visual scene using a camera device of the computing device, the acquired visual scene including at least a first reference marker having predetermined characteristics. Once the scene is acquired, graphical content may be generated having parameters derived from the first reference marker. The graphical content may be superimposed on the acquired at least one visual scene for display on the computing device. A further step of iteratively repeating the steps for display of a plurality of augmented reality images as an image stream on the computing device may also be disclosed. An augmented reality device and a system for generating augmented reality images on a computer device are also disclosed.

### CROSS-REFERENCE TO RELATED APPLICATIONS

This application claims priority to Hong Kong Patent Application No. 14107099.9, filed Jul. 11, 2014, and International Patent Application No. PCT/IB2015/055221, filed Jul. 7, 2015, both of which are hereby incorporated by reference in their entirety.

### TECHNICAL FIELD

The present invention relates to an augmented reality device, system and method of providing an augmented reality display.

### BACKGROUND

Augmented reality (AR) refers to the inclusion of images representative of the real-world environment have been supplemented with computer generated augmentation such as three dimensional graphics, sounds, semantic context or the like. This may be contrasted with Virtual Reality (VR) in which all elements of the displayed image are virtually generated.

Widespread adoption of smart phones, laptop computers and tablets in the general population together with the increased capability for operation of augmented reality software applications on these devices provides a platform upon which augmented reality applications may operate.

In particular, built-in cameras of the portable electronic mobile devices may be used to capture still images of the real-world environment and thus provide the background scene or “reality” on/in which computer generated graphics may be superimposed.

Typically, to create an augmented reality image (combining real elements and computer generated elements) on such a device requires the inclusion in the actual “real world” environment a predetermined visual two dimensional pattern of known size and orientation used as a reference. This reference marker enables the augmented graphics to be constructed/superimposed in the actual image with the correct scale and/or orientation relative to the marker in the combined image(s) produced.

However, successful recognition of the reference marker by the application in the real world image is dependent upon a number of parameters, including ambient lighting conditions, angle of inclination of the device relative to the tracker, and physical size of the tracker. Typically, existing applications use relatively small reference markers, around the size of a playing card or small book.

Possibly due perceived limitations in computational power in the mobile handheld devices, existing augmented reality devices applications typically produce still augmented images only. These augmented reality images have graphical content which is superimposed on a still background image in size and orientation relative to the reference marker detected by the mobile device. It would be appreciated that capturing only still images limits the immersive potential of the augmented reality application, limiting the interactivity between the user with the augmented graphics and the real world scene.

Due to the above limitations, augmented reality applications of prior art mobile device are not able to offer the user the capability to produce interactive, immersive and live-like media contents enriched with a variety of graphical content.

### SUMMARY

Accordingly, it is an object of the present invention to provide an alternative to the above augmented reality systems and methods which addresses or at least alleviates some of the above deficiencies.

Broadly speaking, the present invention describes several broad forms. Embodiments of the present invention may include one or any combination of the different broad forms herein described.

Broadly speaking, the present invention has described a method, system and device for implementation of an augmented reality application.

According to a preferred embodiment of the present invention, there is provided a method for generating augmented reality images for display on a computing device; the method comprising:

acquiring at least one visual scene using a camera device of the computing device, the acquired visual scene including at least a first reference marker having predetermined characteristics;

generating graphical content having parameters derived from the first reference marker;

superimposing said graphical content on the acquired at least one visual scene for display on the computing device.

Preferably, the parameters may be derived from the first reference marker are used to determine one or more of the scale, perspective distortion and angular orientation of the graphical content superimposed on the acquired at least one visual scene.

Optionally, the graphical content may be selected from a library of graphical content, said selection being based upon a predetermined association between the first reference marker and the graphical content.

Preferably, the association of the first reference marker and the graphical content may be dynamically modified based upon an external input.

Optionally, the method further may include iteratively repeating the steps for display of a plurality of augmented reality images as an image stream on the computing device.

Preferably, the displayed images may include graphical content generated on the computing device as a plurality of sequential graphical representations superimposed upon a corresponding plurality of acquired visual scenes.

Alternatively, the displayed images may include a plurality of visual scenes extracted from a video recorded by the computing device.

Preferably, the augmented reality image displayed on the device may be a still image acquired from the image stream.

Optionally, the visual scene further may have at least one other reference marker.

Alternatively, the graphical content may be selected from a library of graphical content based upon a combination of the first reference marker and at least one other reference marker.

Preferably, the graphical content may depict an interaction between graphical content associated with the first reference marker and graphical content associated with at least one other reference marker.

Preferably, the method may further include storing in a memory of the device the superimposed graphical content and the visual scene displayed on said device.

Optionally, the reference markers may be provided on at least one planar surface. The planar surface may be selected from the group comprising: a mat, the hand of a user, a book, a postcard, a poster, a catalogue, a cardboard panel.

Preferably, the reference markers are provided on at least one surface.

Optionally, the reference markers are tattoos. Alternatively, the visual scene may include a person, and wherein the scaling of the graphical content gives the impression of interaction between said graphical content and said person of the visual scene.

In a second aspect, the present invention provides an augmented reality device comprising:

a processor;

an image acquisition component for acquiring at least one image of a visual scene;

a memory containing a program that, when executed by the processor displays content on the display of the augmented reality device, comprising:

acquiring at least one visual scene from the image acquisition component, the acquired visual scene including at least a first reference marker having predetermined characteristics;

generating graphical content having parameters derived from the first reference marker;

superimposing the graphical content on the acquired at least one visual scene for display on the computing device.

In a third aspect of the present invention there is provided an augmented reality device comprising:

a processor;

an image acquisition component for acquiring at least one image of a visual scene;

a memory containing a program that, when executed by the processor displays content on the display of the augmented reality device;

wherein the memory contains a program which is configured to iteratively:

acquire at least one visual scene from the image acquisition component, the acquired visual scene including at least a first reference marker having predetermined characteristics;

generate graphical content having parameters derived from the first reference marker;

superimpose the graphical content on the acquired at least one visual scene for display on the computing device.

Alternatively, the graphical content generated may include a plurality of graphical content having parameters determined by processing of the first reference marker.

In a fourth aspect, the present invention provides a method for generating augmented reality images for display on a computing device; the method comprising:

acquiring at least one visual scene using a camera device of the computing device, the acquired visual scene including at least a first reference marker having predetermined characteristics;

generating graphical content having parameters derived from the first reference marker and associated with a predetermined subject;

superimposing said graphical content on the acquired at least one visual scene for display on the computing device;

wherein the predetermined subject may be associated by the user with an image depicted within the reference markers.

The present invention also provides a method for generating augmented reality images for display on a computing device; the method comprising:

acquiring at least one visual scene using a camera device of the computing device, the acquired visual scene including at least a first reference marker having predetermined characteristics, said reference marker being acquired from a museum;

generating graphical content having parameters derived from the first reference marker and associated with a museum exhibit;

superimposing said graphical content on the acquired at least one visual scene for display on the computing device.

The present invention, may include a system with software configured to perform the above steps of the method. The augmented reality image stream may be displayed, and an application may be included for operation on the computing device. The computing device may be configured such that upon the application starting, preparatory actions may be performed including freeing up random access memory (RAM) by terminating unnecessary processes, clearing application cache memory and creating screen capture (dump file) to be stored in non-volatile memory. These preparatory actions free up system resources to optimize video encoding performance. Typically, a video stream may be encoded with a maximum frame rate of thirty frames per second, depending on computational power of the device.

The present invention provides an interactive and immersive experience, in which elements of the “real world” (visual environment) and a virtual (world interact). These interactions can be modified, according to programmatic or user selection of the graphical content which is associated with the reference markers. Such graphical content, and immersive user environment is limited only by the imagination of the designer of the graphical content.

In addition, in a museum context, the virtual exhibitions created by the method of the present invention require no physical exhibits, eliminating the risks of valuable exhibits being damaged or stolen, and the resources for transporting the same.

### BRIEF DESCRIPTION OF THE DRAWINGS

Preferred embodiments of the present invention will be explained in further detail below by way of examples and with reference to the accompanying drawings, in which:

FIG. 1a depicts a block diagram depicting a computing device operable with an embodiment of the present invention;

FIG. 1b depicts a schematic diagram illustrating a mat suitable for operation with the computer device of FIG. 1a in an embodiment of the invention;

FIG. 2a depicts a schematic representation of an augmented reality device according to an embodiment of the invention.

FIG. 2b depicts an exemplary augmented reality image appearing on the device depicted in FIG. 1a;

FIG. 2c depicts a further exemplary augmented reality image appearing on the computing device depicted in FIG. 1a;

FIG. 3a depicts a display of an augmented reality image according to an embodiment of the present invention;

FIG. 3b depicts a further display of an augmented reality image according to a further embodiment of the present invention;

FIG. 3c depicts yet a further display of an augmented reality image according to a further embodiment of the present invention;

FIG. 4 depicts a flow diagram illustrating a method for displaying content on the augmented reality device according to an embodiment of the present invention;

FIG. 5 depicts an embodiment of the present invention in which two planar surfaces are included in the same visual scene;

FIG. 6 depicts an embodiment of the present invention in which the surface is the upper portion of the user's hand having a tattoo;

FIG. 7a depicts an exemplary display of an augmented reality image according to an embodiment of the present invention;

FIG. 7b depicts a further exemplary display of an augmented reality image according to an embodiment of the present invention;

FIG. 7c depicts a further exemplary display of an augmented reality image according to an embodiment of the present invention.

### DETAILED DESCRIPTION

In a first broad form of the present invention there is presented a method for displaying augmented reality images on the display screen of a computing device, in which graphical content is superimposed on a visual scene.

In a further broad form of an embodiment of the present invention, the images are displayed sequentially in an image stream.

As would be appreciated, the term an “augmented reality image” as used herein refers to a real time view of a physical real world environment which has been supplemented with graphical elements from a computing environment. The graphical content which is superimposed in the image of the real world (captured by the computing device) and together form the “augmented reality image”.

As such it would be appreciated that the augmented reality image viewed by a user includes elements of a virtual world, together with elements of the environment in which the user is located. This may be compared to a “virtual reality” environment in which all of the elements are computer generated.

As referred to herein the term “ graphical content” refers to graphical elements or the like which have been generated by the computing device and which may be representative of animals, entities, characters or even text, the actual nature of which is constrained only by the imagination of the designer.

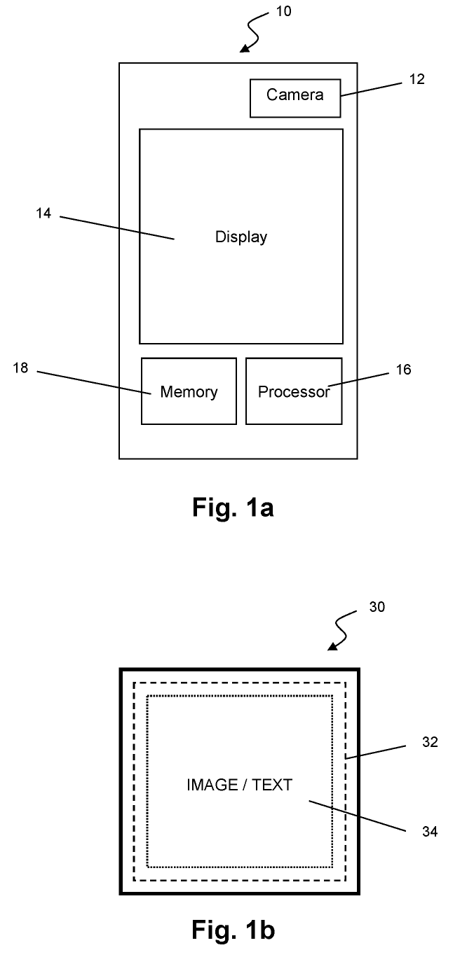

As shown, the device 10 of FIG. 1a is a device capable of performing as an augmented reality device and includes components familiar to persons skilled in the art, and persons of the general public. The augmented reality device 10 includes a camera 12, a display screen 14, a processor 16 and a memory store 18. It would be appreciated that a number of arrangements of such device would be possible, and the elements denoted are shown as indicative only.

FIG. 1b depicts a surface 30 or mat which can be used with an embodiment of the present invention. It would be appreciated that the surface may be included as a single surface, or multiple adjacent or proximal surfaces or mats, which may be generally planar, although not exclusively.

By way of example, the surface 30 may be provided as a book, notepad or the like, or may be selected from other generally planar surfaces such as that of a user's hand, or portion of the user's body.

In one embodiment of the present invention (not shown), it is understood that the reference markers may be included on one, two or a plurality of planar surfaces of a three-dimensional object such as cube, prism or other shapes of surfaces).

Alternatively, a three-dimensional object having a plurality of different and substantially non planar surfaces supporting the reference markers may be used. By way of example, the three-dimensional object may be an action figure, toy furniture, or the like.

The surface 30 includes a reference marker 32 comprising indicia which are formed in a predetermined pattern on the surface. These indicia may be formed as temporary or permanent markings on the surface. Where the surface is a portion of the user's palm, a temporary or permanent tattoo may be applied to this surface, thereby providing the representative indicia.

As is appreciated by persons skilled in the art, the reference marker 32 formed on the surface may be formed so as to be processed by algorithms in the processor of the augmented reality device 10. Optionally, the mat may include an image or text 34 in the central portion of the planar surface.

As noted above, visual characteristics of the three-dimensional object are captured and processed by the algorithms in the processor of the augmented reality device 10 in a similar manner as the planar surface 30.

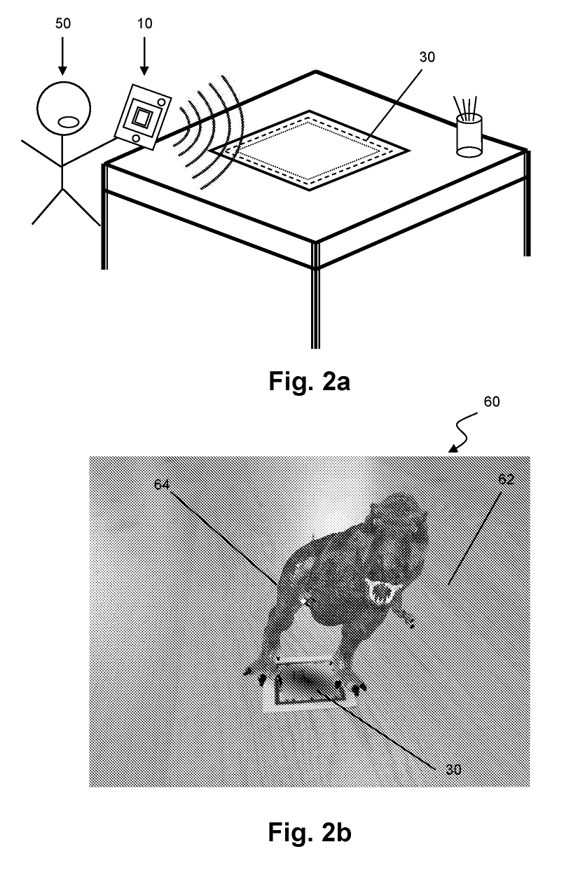

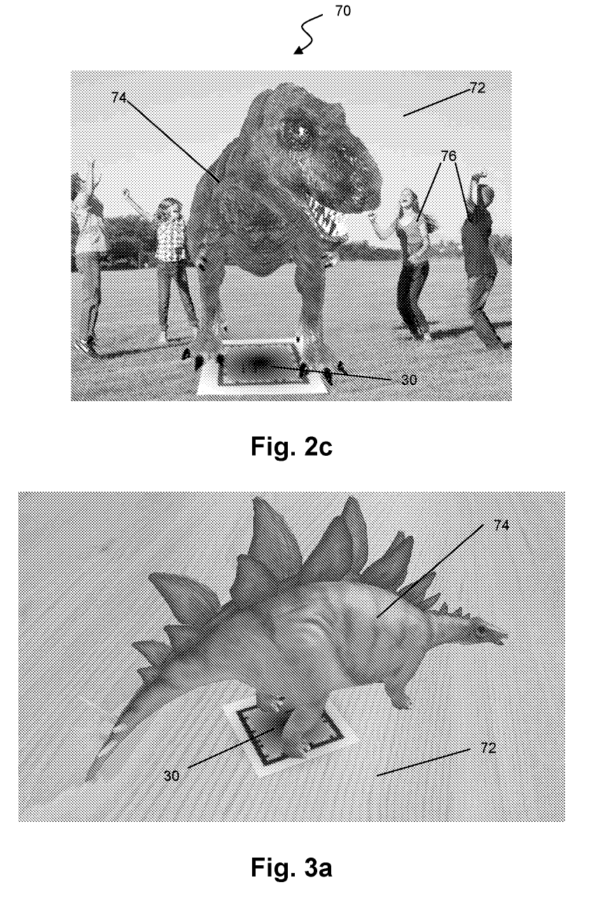

Referring now to FIG. 2a, there is shown a stylized representation of a possible use of the present invention. The user 50 holds the device 10 at an angle inclined to the planar surface 30. The user 50 is able to acquire a still or video image of the mat 30 on the table 36, and the still or video image acquired is stored on the device 10. As is described in more detail hereafter, the images displayed on the display 14 of the device 10 may include graphical elements which have been generated according to sizing and scaling parameters of the reference marker, together with the image actually captured by the camera 12 of the device 10.

Referring to FIG. 2b, it can be seen that a typical augmented reality image 60 according to the present invention includes a background component 62 which corresponds to the actual environment in which the user is physically present. In addition, the image contains the planar surface 30 and generated graphical content 64 which has been scaled according to parameters derived from the reference marker 32 of the mat 30.

As is known in the art, the detection of the reference markers 32 located in the periphery or border of the planar surface 30 means that the graphical content 64 included in the image can be scaled relative to the reference marker.

Essentially, algorithms determined and detect the scale and orientation of the reference markers in the image, and scaled and orient the superimposed graphical content 64 accordingly.

This is discussed in more detail below.

FIG. 2c depicts an augmented reality image 70 in which the background 72 and graphical content 74 are included, together with real people 76 interacting with the graphical content 74 shown in the augmented reality image 70.

To enhance the potential of interactivity between the persons 76 and the graphical content 74 depicted in the augmented reality image, the planar surface 30 may be provided in a large form factor.

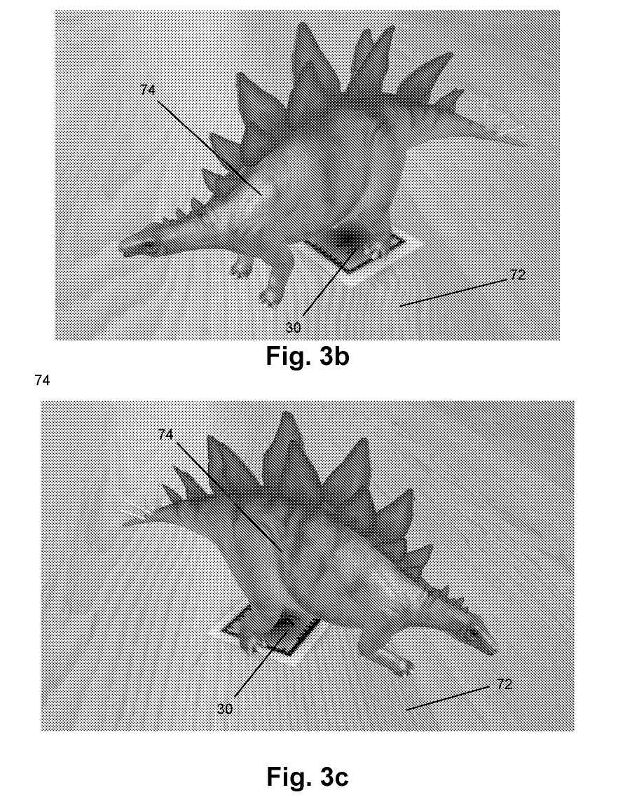

Referring now to FIGS. 3a to 3c, it can be seen that these Figures depict representative still images which may be obtained from a video captured according to the present invention.

In the first Figure, FIG. 3a, the graphical content 74 is depicted in a first orientation relative to the actual background 72. (In this case, the graphical content is a stegosaurus, however it would be appreciated by persons in the art that such graphical content could include whatever animal or other entity it is possible to graphically represent).

Referring to FIG. 3b, it can be seen that the graphical content depicted (the stegosaurus 74) is depicted in a side on orientation relative to the background 72.

Furthermore, it can be seen that the graphical content 74 (stegosaurus) has changed position relative to the background depicted in FIG. 3b and the background depicted in FIG. 3c.

It will be appreciated that the combination of the frames of the graphical content with the background, would produce an appearance of the graphical content moving in a real world environment.

As would further be appreciated, the inclusion of persons (such as those depicted in FIG. 2c) in such a movie in which the graphical content appears to move, provides an enhanced degree of perceived interactivity between the persons in the real world, and the depicted graphical content.

Accordingly, this provides for a high degree of potential engagement for persons appearing in the “movie” (or even in a series of still images). This is of course, particularly appealing to younger children, seeking an interesting and immersive learning experience.

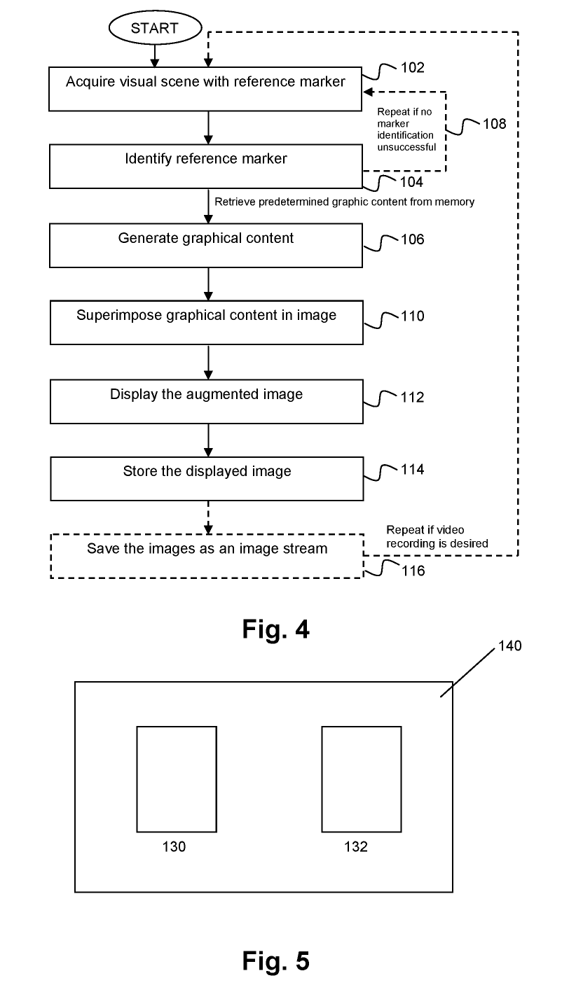

As depicted in the flow chart shown in FIG. 4, the method of the present invention involves a number of steps.

A visual scene is acquired at step 102, the visual scene including the actual real world environment, which includes a planar surface 30 having reference markers 32. The acquired image(s) are processed by the processor of the computing device to identify the presence of the reference markers in the image, together with the relative orientation, scaling, and distance of the computing device relative to the reference markers.

Based upon the derived values calculated for the reference markers identified as appearing in the image, similar parameters for adjusting the graphical components may be determined. Based upon a unique code, or other identifier included in the reference markers (for example in the specific sequence of lines and dots), graphical content corresponding to the unique identifier may be retrieved from memory, at step 106.

However, if the identification of a reference markers is unsuccessful after a given time limit, it may be necessary to prompt the user to re-acquire the image at step 108 (an optional step) to re-acquire the image.

Once the reference markers have been identified together with the appropriate parameters to adjust the appearance, graphic content may be generated appropriate to the reference markers in step 106.

As noted above, the actual graphic content generated is constrained only by the imagination of the designer. An association between the detected reference pattern, and a library of graphic content would allow virtually any graphic content to be triggered upon detection of a reference marker, according to a mapping. It will be appreciated by the persons skilled in the art that the association between the detected reference marker and the graphical content may be modified either through user input, programme modification, random association, or through any other such pre-determined or dynamically determined association.

This particularly would ensure that notwithstanding the same reference marker was present, a variety of generated graphical content with different behaviour may be produced.

For example, a stegosaurus may be produced having a first movement pattern where the day is a Monday, and a different dinosaur or different movement pattern may be produced if the date and time are different.

Upon generation of the graphical content in step 106, the graphical content generated is superimposed in the image of the real world scene that was acquired in step 102, as denoted by step 110.

The graphical content and acquired image may be displayed on the computing device as denoted by step 112.

Optionally, the graphical content and visual scene may be stored on the computing device in step 114.

In still a further optional embodiment, the images may be stored as an image stream in step 116 on the computing device.

It would be appreciated that the images could be acquired in real time, or a still image of a plain background may be acquired, with the animated graphical content superimposed thereon.

Advantageously, the system may include software configured to perform the above steps of the method. In an embodiment where an augmented reality image stream is displayed, an application may be included for operation on the computing device. The computing device may be configured such that upon the application starting, preparatory actions may be performed including freeing up random access memory (RAM) by terminating unnecessary processes, clearing application cache memory and creating screen capture (dump file) to be stored in non-volatile memory. This frees up system resources to optimize video encoding performance. Typically, a video stream may be encoded with a maximum frame rate of thirty frames per second, depending on computational power of the device.

Furthermore, it would be appreciated that the determination of the parameters associated with the reference markers in the acquired scene may include one or more of the scale, distortion or angular orientation adjustment which is then applied to the graphical content superimposed on the acquired scene.

It would be appreciated that the capacity to store and record a plurality of augmented reality images in an image screen allows for a particular immersive experience. This is further enhanced, if a person or persons is included in the acquired image screen.

It would further be appreciated that to reduce processing time and complexity, only a selected number of images of the background scene may be acquired from the video footage of the background scene, these images being included together with the superimposed graphical content.

It would be further appreciated that the possibility for the user to capture a still image from the image screen could optionally be provided to the user.

Referring now to FIG. 5, there is shown a plurality of planar surface in the reference markers 130, 132 which had been captured in the same visual scene 140. This provides the capacity for two reference markers to be detected from the acquired visual scene, with graphical content determined with appropriate parameters derived from each reference marker.

It would be appreciated by persons skilled in the art, that the graphical content where two reference markers are detected could be configured so as to give the appearance of the interaction between the graphical content generated from the first reference marker, and the graphical content generated from the second reference marker.

Further, it would be appreciated that the nature, and identity of the graphical content generated may be determined solely through the inclusion of both reference markers, producing graphical content which would otherwise not be accessible to the users.

Advantageously, the present invention provides an interactive and immersive experience, in which elements of the “real world” (visual environment) and a virtual (world interact). These interactions can be modified, according to programmatic or user selection of the graphical content which is associated with the reference markers. Such graphical content, and immersive user environment is limited only by the imagination of the designer of the graphical content.

Furthermore, the capacity for capturing real time video of a user appearing to interact with graphical content in a known real world environment further enhances the experience of the users. Perceived interaction of a person with the graphical content may be further enhanced if the capacity is provided to include recordal of the users' sounds together with sounds generated by the computing device.

Accordingly, the movement of the graphical element in the real world environment, the voice of the person in the captured image or video stream together with any additional generated sounds could be combined to produce, for example, a video depicting “little Johnny's wrestling with a dinosaur” in real time. Such a video could be saved and shared with family and friends as a novelty or educational footage to engage younger persons particularly.

It would be appreciated that such capacity as provided by the present invention allows for development of story telling skills, and many other applications with an element of personalized presentation, where the persons and background appearing in a real world environment are combined with one or more simulated graphical elements.

Accordingly, the present invention allows for the co-ordination of short “movies” in which people, the environment and graphical elements appear to interact.

Optionally, an embodiment of the present invention may include a planar surface which includes reference markers which can be processed by a computing device to retrieve an associated library of graphical content. Similarly, in the case where a three-dimensional object is used in substitution of the planar surface, the visual characteristics of such object are captured and interpreted by the computing device to retrieve the associated graphical content in the library.

The subject of the library of graphical content can include whatever a graphical designer is able to imagine would be appropriate. The graphical content may be downloaded and stored on the device with a software application, or alternatively downloaded from a central repository upon acquisition of the reference marker by the device, or in other arrangements without departing from the scope of the present invention.

By way of example, the surface may include reference markers which upon processing by the computing device of an acquired image including the reference markers cause the display of graphical content of a dinosaur, for example a Stegosaurus. Accordingly, the surface may be sold as a mat, or a catalogue or a book either separately or in combination with other mats which may be sold at a museum, bookshop, cafeteria or the like.

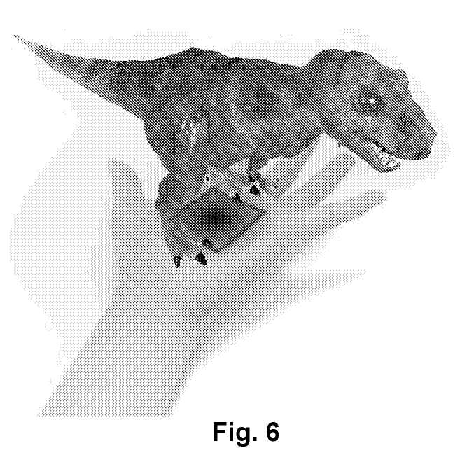

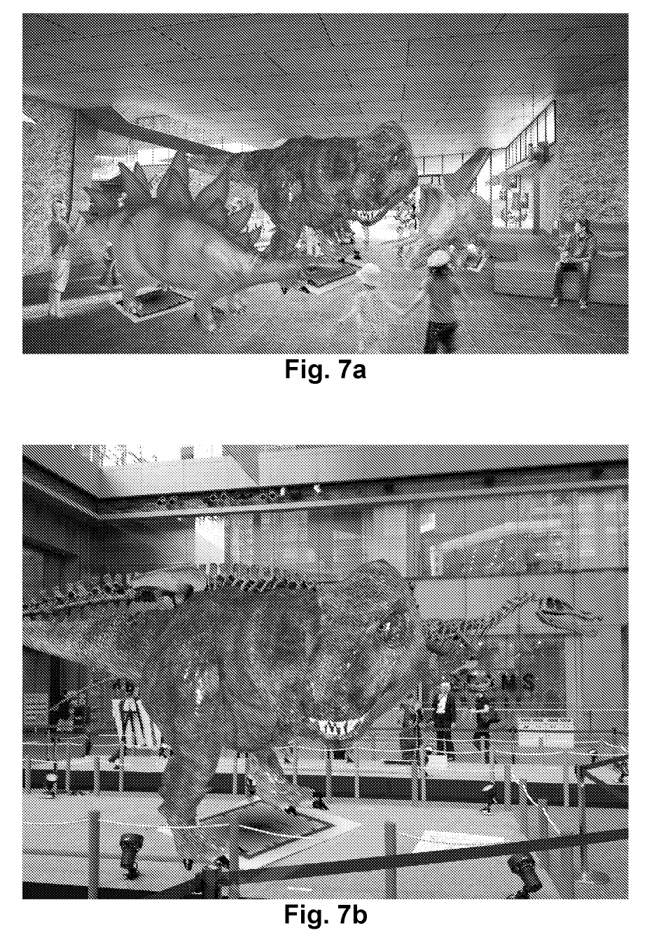

In still a further embodiment, as depicted in FIG. 6, the surface could actually be the upper portion of the user's hand, to which a temporary tattoo with appropriate indicia has been applied.

Upon visiting the museum, and purchasing the mat or temporary tattoo (etc), the user may be able to download a software application on a portable computing device. The computing device may be a tablet computer or communications device having an image acquisition function, together with the capacity to operate a software application.

As previously described, although the “value” of the acquired image marker does not change, the association of the marker with the graphical content could be modified by user input, day of the week, presence of an additional marker, which may be remote to the user or by some other means of modification without departing from the present invention.

For example, the planar surface purchased by the user from the Museum during a dinosaur promotion may generate a Stegosaurus on Mondays, a Tyrannosaurus on Tuesdays and a Triceratops on Wednesdays. Once the dinosaur promotion has finished, the same reference marker may be used to generate an Orangutan the first time it is accessed, a Lion the second time it is accessed, and an Eagle the third time. Other arrangements are of course possible.

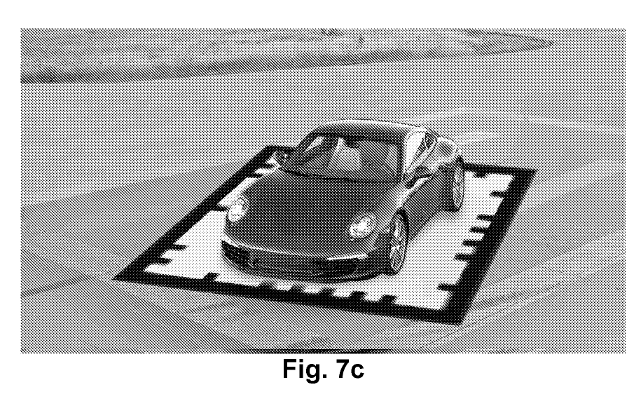

Referring now to FIGS. 7a to 7b, there is shown an embodiment in which a virtual museum experience may be created. As depicted, by way of example, by placing mats having reference markers in an exhibition area in the physical real world environment of a museum or hall. The graphical contents associated with these reference markers according the present invention as described herein is then will be generated on the computing device to produce a combined imagery with both the virtual “exhibits” and the real world environment visible on the computing device.

It may be appreciated that in other exemplary uses of the present invention, similar methods as hereinbefore described may be employed to showcase large or bulky merchandise goods which would be difficult to be placed in premises with limited space, such as demonstration of a sports car as depicted in FIG. 7c.

Advantageously, virtual exhibitions created by the aforementioned method require no physical exhibits, eliminating the risks of valuable exhibits being damaged or stolen, and the resources for transporting the same.

While the present invention has been explained by reference to the examples or preferred embodiments described above, it will be appreciated that those are examples to assist understanding of the present invention and are not meant to be restrictive. Variations or modifications which are obvious or trivial to persons skilled in the art, as well as improvements made thereon, should be considered as equivalents of this invention.

Furthermore, while the present invention has been explained by reference to specific types of graphical content and a portable mobile device it should be appreciated that the invention can apply, whether with or without modification, to other types of graphical content and other devices which contain the requisite elements without loss of generality.

1. A method for generating augmented reality images for display on a computing device, the method comprising:
acquiring at least one visual scene using a camera device of the computing device, the acquired visual scene including at least a first reference marker having predetermined characteristics;
generating graphical content having parameters derived from the first reference marker;
superimposing said graphical content on the acquired at least one visual scene for display on the computing device.

2.-22. (canceled)

23. The method for generating augmented reality images for display on a computing device according to claim 1, wherein the parameters derived from the first reference marker are used to determine one or more of the scale, perspective distortion and angular orientation of the graphical content superimposed on the acquired at least one visual scene.

24. The method for generating augmented reality images for display on a computing device according to claim 1, wherein the graphical content is selected from a library of graphical content, said selection being based upon a predetermined association between the first reference marker and the graphical content.

25. The method for generating augmented reality images for display on a computing device according to claim 24, wherein association of the first reference marker and the graphical content is dynamically modified based upon an external input.

26. The method for generating augmented reality images for display on a computing device according to claim 1, further including iteratively repeating the steps for display of a plurality of augmented reality images as an image stream on the computing device.

27. The method for generating augmented reality images for display on a computing device according to claim 1, wherein the displayed images include graphical content generated on the computing device as a plurality of sequential graphical representations superimposed upon a corresponding plurality of acquired visual scenes.

28. The method for generating augmented reality images for display on a computing device according to claim 27, wherein the displayed images include a plurality of visual scenes extracted from a video recorded by the computing device.

29. The method for generating augmented reality images for display on a computing device according to claim 26, wherein the augmented reality image displayed on the device is a still image acquired from the image stream.

30. The method for generating augmented reality images for display on a computing device according claim 1, wherein the visual scene has at least one or more further reference markers.

31. The method for generating augmented reality images for display on a computing device according to claim 30, wherein the graphical content is selected from a library of graphical content based upon a combination of the first reference marker and the at least one or more further reference markers.

32. The method for generating augmented reality images for display on a computing device according to claim 31, wherein the graphical content depicts an interaction between graphical content associated with the first reference marker and graphical content associated with the at least one or more further reference markers.

33. The method for generating augmented reality images for display on a computing device according to claim 1, further including storing in a memory of the device the superimposed graphical content and the visual scene displayed on said device.

34. The method for generating augmented reality images for display on a computing device according claim 1, wherein the reference markers are provided on at least one planar surface.

35. The method for generating augmented reality images for display on a computing device according to claim 34, wherein the planar surface is selected from the group comprising: a mat, the hand of a user, a book, a postcard, a poster, a catalogue, a cardboard panel.

36. The method for generating augmented reality images for display on a computing device according to claim 1, wherein the reference markers are provided on at least one surface.

37. The method for generating augmented reality images for display on a computing device according to claim 1, wherein the reference markers are tattoos.

38. The method for generating augmented reality images for display on a computing device according to claim 1, wherein the visual scene includes a person, and wherein the scaling of the graphical content gives the impression of interaction between said graphical content and said person of the visual scene.

39. An augmented reality device comprising:
a processor;
an image acquisition component for acquiring at least one image of a visual scene;
a memory containing a program that, when executed by the processor displays content on the display of the augmented reality device, comprising:
acquiring at least one visual scene from the image acquisition component, the acquired visual scene including at least a first reference marker having predetermined characteristics;
generating graphical content having parameters derived from the first reference marker;
superimposing the graphical content on the acquired at least one visual scene for display on the computing device.

40. The augmented reality device according to claim 39, wherein the graphical content generated includes a plurality of graphical content having parameters determined by processing of the first reference marker.

41. A system for generating augmented reality images for display on a computing device; the system comprising:
acquiring at least one visual scene using a camera device of the computing device, the acquired visual scene including at least a first reference marker having predetermined characteristics;
generating graphical content having parameters derived from the first reference marker and associated with a predetermined subject;
superimposing said graphical content on the acquired at least one visual scene for display on the computing device;
wherein the predetermined subject is associated by the user with an image depicted within the reference markers.
